(19) United States
(12) Patent Application Publication
(10) Pub. No.: US 2026/0326130 A1
(43) Pub. Date: Oct. 22, 2026

(54) PISTON FOR A CONTAINER PROVIDED WITH AN AIRLESS DISPENSER FOR A FLUID PRODUCT, SUCH AS A COSMETIC PRODUCT

(71) Applicant: BARALAN INTERNATIONAL S.P.A., Trezzano Sul Naviglio (MI) (IT)

(72) Inventors: Roland BARANES, Milano (IT); Maurizio FICCADENTI, Torino (IT)

(21) Appl. No.: 19/100,473

(22) PCT Filed: Aug. 4, 2023
(86) PCT No.: PCT/IB2023/057894

§ 371 Date: Jan. 31, 2025

(30) Foreign Application Priority Data
Aug. 5, 2022 (IT) 102022000016779

(51) Int. Cl. B05B 11/02; B65D 83/76

(52) U.S. Cl. CPC B05B 11/028; B65D 83/765

(57) ABSTRACT

A piston includes a main body having an outer lateral wall. A peripheral sealing portion protrudes transversally outwards from the outer lateral wall and extends perimetrically in a substantially continuous manner around the main body. The peripheral sealing portion is configured to fluid-sealingly slide in a receptacle defined by the inner lateral surface of a hollow reservoir of a container. The piston has a plurality of lateral extensions protruding transversally outwards from the outer lateral wall and being mutually spaced apart along the perimeter of the main body. The lateral extensions are axially spaced from the peripheral sealing portion and are configured to slide against the inner lateral surface of the hollow reservoir, to guide movement of the piston in the receptacle.

### TECHNICAL FIELD

The present invention relates to a piston for a container provided with an airless dispenser for a fluid product, such as a cosmetic product.

### Technical Background

With particular reference to the cosmetic field, it is known to use containers for dispensing a fluid product (e.g. liquid or gel), typically in a plurality of doses. In order to still be able to preserve the product while reducing the use of preservatives, airless (or airtight) dispensers have been conceived which generally employ a mechanical vacuum pump that controls the movement of a piston capable of pushing the product contained in a chamber towards a dispensing nozzle, while keeping it enclosed in the chamber under fluid-tight conditions to avoid contamination. In this manner, the airless dispenser ensures product dispensation while, in particular, protecting the non-dispensed part of the product from contact with air.

By way of example, in FIGS. 1 and 2, 10 designates a container of the above-specified type made in accordance with the prior art. Container 10 comprises a hollow reservoir 12, typically made of transparent or translucent material, which internally defines a receptacle 14 configured to sealingly contain a fluid product P, such as a cosmetic product, typically to be dispensed in a plurality of doses at different times. Container 10 also comprises a piston 100 slidably and fluid-sealingly mounted inside receptacle 14 and intended to be in contact with product P to be dispensed. The container further comprises an airless dispenser 16 mounted on hollow reservoir 12 and operable by a user to create in receptacle 14 a vacuum acting upon piston 100. Every time airless dispenser 16 is operated, piston 100 is attracted and pushes an amount or dose of product P contained in receptacle 14 out of hollow reservoir 12.

As is typically the case in the prior art, piston 100 comprises a main body 102 having an outer lateral wall 104. In addition, piston 100 comprises a pair of peripheral sealing portions 106 protruding from outer lateral wall 104, extending perimetrically in a substantially continuous manner around main body 102 and axially spaced apart. Peripheral sealing portions 106 are configured to slide in receptacle 14, under fluid-tight conditions, against the inner lateral wall of hollow reservoir 12.

However, such a piston type suffers from a number of drawbacks.

In fact, when piston 100 is operating in container 10, Sealing portions 106 of main body 102 are both in contact with the inner wall of hollow reservoir 12. A perimetric air volume, designated as A, is thus defined, which is comprised between sealing portions 106 in the axial direction and between outer lateral wall 104 of main body 102 and the inner lateral wall of hollow reservoir 12 in the transversal direction. Perimetric air volume A is axially adjacent to product P to be dispensed, and outer lateral wall 104 is visible outside hollow reservoir 12. Therefore, when piston 100 is inside receptacle 14 of hollow reservoir 12, the presence and visibility of outer lateral wall 104 through perimetric air volume A make container 10, in its entirety, not very aesthetically pleasing.

U.S. Pat. No. 11,370,597 B2 describes a piston for a reservoir of a dispenser of a fluid product without air intake, and presenting a central axis. The piston includes sealing means and also guiding means. The sealing means extend in a plane orthogonal to the central axis and define a single external sealing line in a closed loop, distal from axis X, capable of coming into contact with an inner wall of the reservoir. The guiding means include a base from which one or more tabs with free ends extend, which define external guide points, distal from the central axis, capable of coming into contact with the inner wall of the reservoir.

### SUMMARY OF THE INVENTION

It is one of the objects of the present invention to provide a piston for a container provided with an airless dispenser for a fluid product, such as a cosmetic product, wherein said piston is of an improved type and can solve the problems suffered by the prior art.

According to the present invention, this and other objects are achieved through a piston having the technical features set out in the appended independent claim.

According to a preferred aspect, in particular in comparison with the invention disclosed in U.S. Pat. No. 11,370,597 B2, in a piston made in accordance with the present invention the combined technical features of the peripheral sealing portion and of the lateral extensions accomplish the goal of ensuring better stability in the placement and movement of the piston within the container in which it is intended to be inserted. As a matter of fact, the peripheral sealing lip or the annular sealing gasket(s), on one side, and the teeth or tabs, on the other side, allow the piston to be guided in a more stable and effective manner.

In particular, according to an advantageous aspect of the present invention, when the piston is assembled to the hollow reservoir of a container, the outer lateral wall of the piston is substantially hidden by the product to be dispensed, so that the piston is substantially invisible to user. This also makes the container more aesthetically pleasing in its entirety.

It is understood that the appended claims are an integral part of the technical teachings provided in the following detailed description of the present invention. In particular, the appended dependent claims define some preferred embodiments of the present invention that include some optional technical features.

### BRIEF DESCRIPTION OF THE DRAWINGS

Further features and advantages of the present invention will become apparent in light of the following detailed description, provided herein merely as a non-limiting example and referring, in particular, to the annexed drawings as summarized below.

FIGS. 1 and 2 are longitudinal sectional views of a container provided with an airless dispenser for a fluid product, inserted in a cavity of the container. Said container is also equipped with a piston made in accordance with the prior art.

FIGS. 3 and 4 are longitudinal sectional views similar to those shown in FIGS. 1 and 2, wherein the container is provided with a piston made in accordance with an illustrative embodiment of the present invention.

FIGS. 5 to 8 are, respectively, a perspective view, a top view, a side elevation view and a longitudinal sectional view of the piston shown in FIGS. 3 and 4.

FIGS. 9 to 14 include two longitudinal sectional views of a container and, respectively, a perspective view, a top view, a side elevation view and a longitudinal sectional view of a piston made in accordance with a second illustrative embodiment of the present invention and contained in said container.

FIGS. 15 to 17 include a longitudinal sectional view of a container and, respectively, a side elevation view and a longitudinal sectional view of a piston made in accordance with a third illustrative embodiment of the present invention and contained in said container.

FIGS. 18 to 20 include a longitudinal sectional view of a container and, respectively, a side elevation view and a longitudinal sectional view of a piston made in accordance with a fourth illustrative embodiment of the present invention and contained in said container.

FIGS. 21 to 25 include a longitudinal sectional view of a container and, respectively, a perspective view, a top view, a side elevation view and a longitudinal sectional view of a piston made in accordance with a fifth illustrative embodiment of the present invention and contained in said container.

FIGS. 26 to 31 include two longitudinal sectional views of a container and, respectively, a perspective view, a top view, a side elevation view and a longitudinal sectional view of a piston made in accordance with a sixth illustrative embodiment of the present invention and contained in said container.

FIGS. 32 to 34 include a longitudinal sectional view of a container and, respectively, a side elevation view and a longitudinal sectional view of a piston made in accordance with a seventh illustrative embodiment of the present invention and contained in said container.

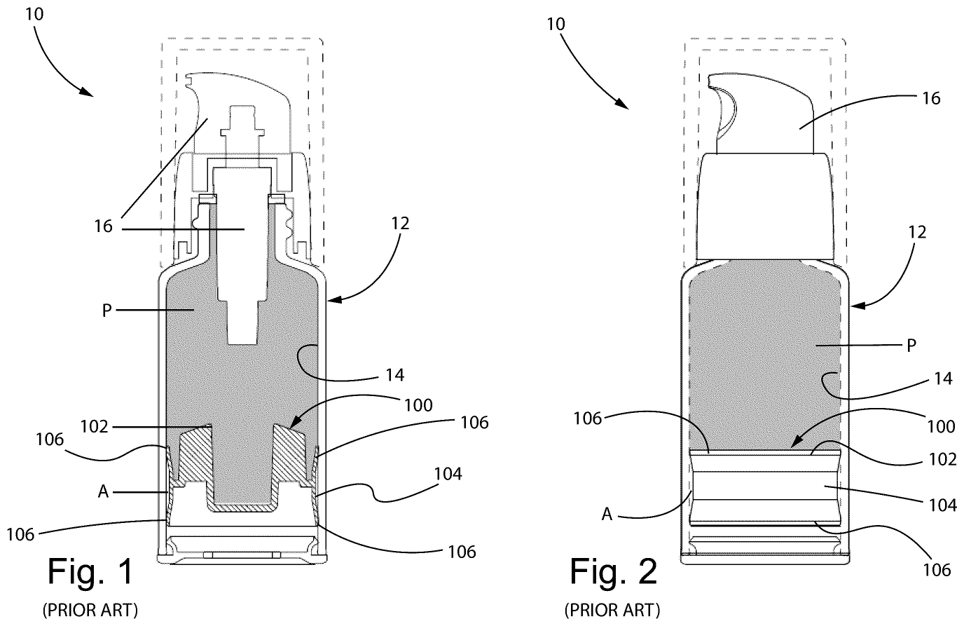

For completeness' sake, the following is a list of alphanumerical references and names used herein to identify parts, elements and components illustrated in the above-summarized drawings.
P. Fluid product
10. Container
12. Hollow reservoir
14. Receptacle
16. Airless dispenser
100. Piston
102. Main body
104. Outer lateral wall
106. Peripheral sealing portion
108. Lateral extension
110. Peripheral sealing lip
112. Teeth
114. Central part
116. Central cavity
118. Intermediate annular section
120. Annular sealing gasket
122. Recesses
124. Tab
124a. Stem portion
124b. Head portion
126. Arms
128. Lateral apertures
130. Base plate

### DETAILED DESCRIPTION OF THE INVENTION

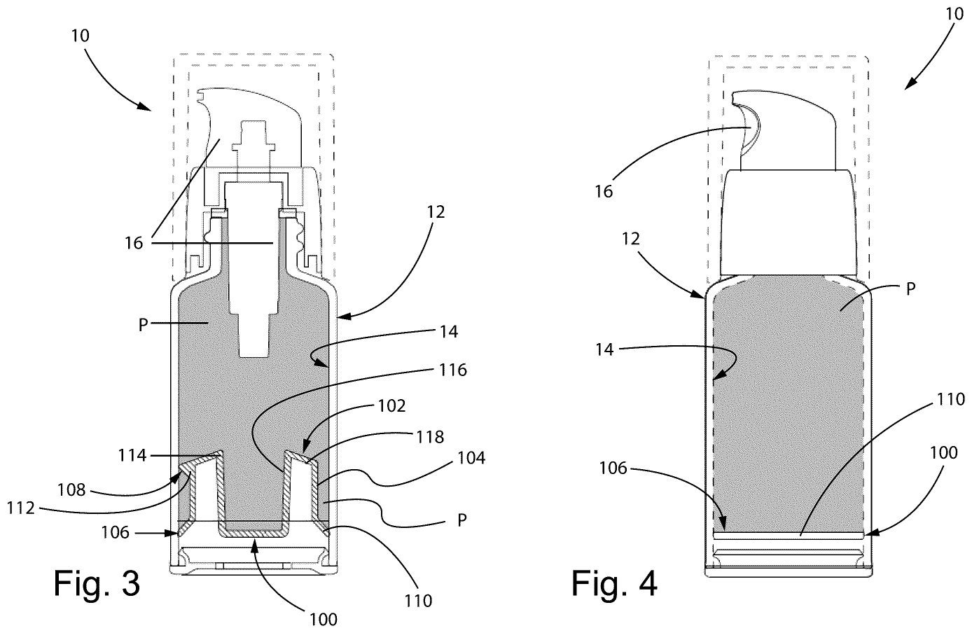

With reference to FIGS. 3 to 8, there is shown as a whole a container 10 provided with an airless dispenser 16 for a fluid product P, such as a cosmetic product, and comprising a piston 100 made in accordance with a first illustrative embodiment of the present invention.

As shown in FIGS. 3 and 4, container 10 comprises a hollow reservoir 12, generally made of transparent or translucent material. Hollow reservoir 12, e.g. shaped substantially as a bottle, internally defines a receptacle 14 configured to sealingly contain a fluid product P, such as a cosmetic product, typically to be dispensed in a plurality of doses at different times. As mentioned above, the container further comprises piston 100, which is configured to be slidably and fluid-sealingly mounted inside receptacle 14 and which is intended to be in contact with product P to be dispensed. Container 10 comprises also an airless dispenser 16 mounted on hollow reservoir 12, in particular at one end thereof, which in the illustrated embodiment is the top end. Airless dispenser 16 is operable by a user to create in receptacle 14 a vacuum acting upon piston 100. Every time airless dispenser 16 is operated, piston 100 is attracted and pushes an amount or dose of product P contained in receptacle 14 out of hollow reservoir 12, in particular through an orifice 18 formed through airless dispenser 16.

In the illustrated embodiment, airless dispenser 16 comprises a mechanical pump operable by a user. In further variant embodiments, airless dispenser 16 may employ other devices different from a mechanical pump, e.g. a syringe, to create the vacuum that attracts piston 100.

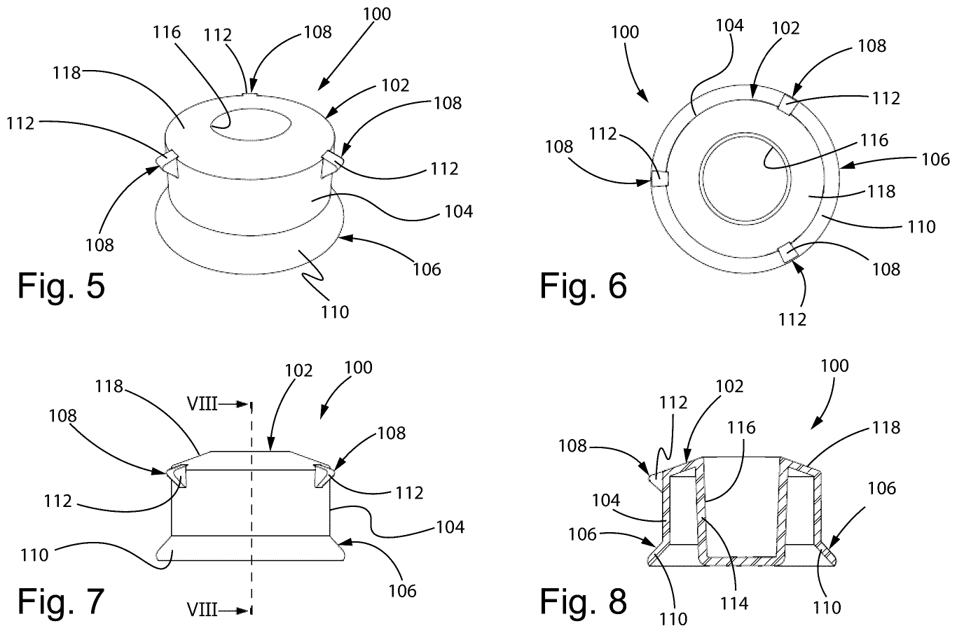

With particular reference to FIGS. 5 to 8, piston 100 comprises a main body 102 having an outer lateral wall 104. In addition, piston 100 comprises a peripheral sealing portion 106 protruding transversally outwards from outer lateral wall 104. Peripheral sealing portion 106 extends perimetrically in a substantially continuous manner around main body 102. Moreover, peripheral sealing portion 106 is configured to slide in receptacle 14, under fluid-tight conditions, against the inner lateral wall of hollow reservoir 12.

Piston 100 further comprises a plurality of lateral extensions 108 protruding transversally outwards from outer lateral wall 104 and being mutually spaced apart along the perimeter of main body 102. Lateral extensions 108 are axially spaced from peripheral sealing portion 106. Also, lateral extensions 108 are configured to slide against the inner lateral wall of hollow reservoir 12, thereby guiding the movement of piston 100 within receptacle 14.

In this way, with piston 100 installed in container 10, product P contained in receptacle 14 can flow through the spaces laterally defined between lateral extensions 108, thus covering outer lateral portion 104 and lapping the inner surface of hollow reservoir 12. In other words, product P can, as opposed to prior-art pistons, fill up the perimetric region axially comprised between lateral extensions 108 and the peripheral sealing portion 106 without any substantial air volume being generated therein. In this manner, piston 100 turns out to be substantially hidden by product P to be dispensed, so that said piston 100 is substantially “invisible” in hollow reservoir 12. In fact, the only visible part of piston 100 is peripheral sealing portion 106.

The following will describe some ther preferred technical features of piston 100 according to the present invention.

Preferably, peripheral sealing portion 106 and lateral extensions 108 are situated on axially opposite sides of main body 102. For example, peripheral sealing portion 106 is situated at (or near) the bottom of main body 102, whereas lateral extensions 108 are situated at (or near) the top of main body 102.

Preferably, main body 102 of piston 100 is made of plastic, more specifically thermoplastic material (e.g. by moulding).

Preferably, sealing portion 106 is made as one piece with main body 102.

In the embodiment illustrated in FIGS. 5 to 8, peripheral sealing portion 106 comprises a peripheral sealing lip 110 that protrudes from outer lateral wall 104 and extends continuously around main body 102. In particular, peripheral sealing lip 110 extends transversally outwards from the bottom of main body 102.

Preferably, lateral extensions 108 are made as one piece with main body 102.

Preferably, lateral extensions 108 are mutually and evenly spaced apart around the perimeter of outer lateral wall 104 of main body 102.

In the embodiment illustrated in FIGS. 5 to 8, the plurality of lateral extensions 108 comprise a plurality of teeth 112 mutually (and evenly) spaced apart along outer lateral wall 104 of main body 102. In particular, teeth 112 have a substantially triangular cross-section with a vertex configured to stay in contact with the inner wall of hollow reservoir 12.

With particular reference to FIG. 8, main body 102 further comprises a central part 114 joined to outer lateral wall 104. In particular, central part 114 is substantially cup-shaped and has a central cavity 116 intended to receive part of airless dispenser 16 when piston 100 is attracted near airless dispenser 16. Preferably, central part 114 has a substantially circular cross-section.

Advantageously, outer lateral wall 104 externally surrounds central part 114 and hides it perimetrically. Preferably, main body 102 comprises also an intermediate annular section 118 that joins outer lateral wall 104 and central part 114 transversally and perimetrically, in particular at the top of main body 102. By way of example, starting from the top of outer lateral wall 104, intermediate annular section 118 joins the top of central part 114, in particular by tapering upwards. Particularly, intermediate annular section 118 is configured to abut, when piston 100 is attracted near airless dispenser 16, on respective shoulder portions (not numbered and, for example, formed in the tapered portion near the neck) of hollow reservoir 12. Preferably, outer lateral wall 104, central part 114 and intermediate annular section 118 are made as one piece, in particular as a monolithic main body 102.

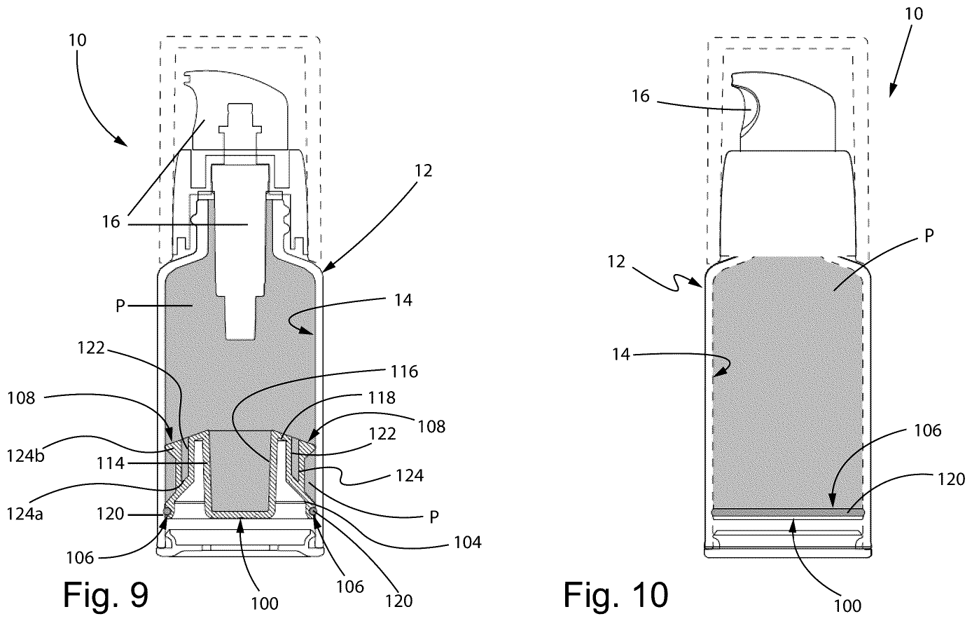

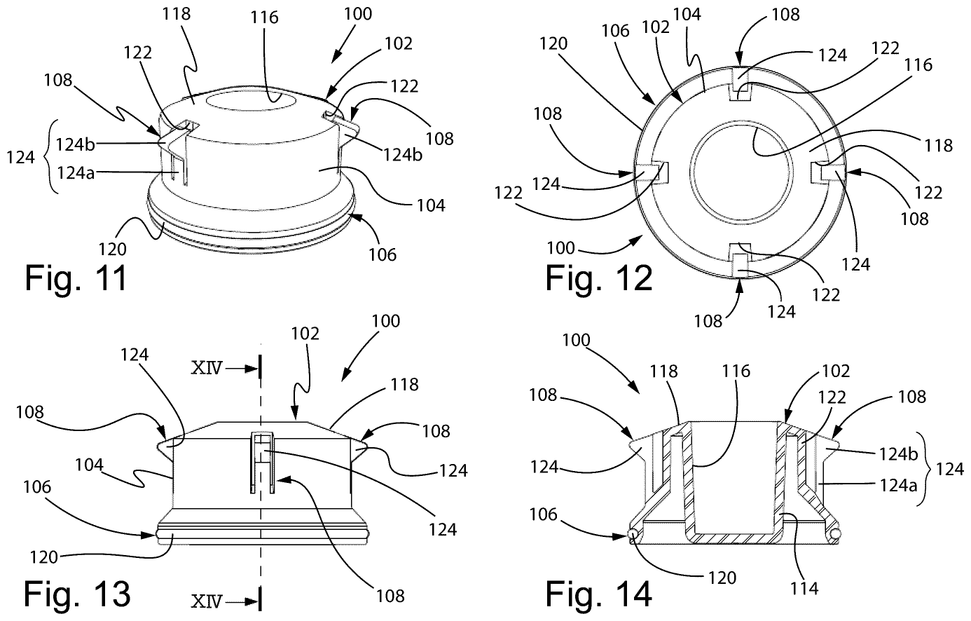

With reference to FIGS. 9 to 14, there is shown a container, still designated as 10, provided with a piston, still designated as 100, made in accordance with a second illustrative embodiment of the present invention.

Those parts and elements which are similar to- or which perform the same function as-those of the above-described embodiment have been assigned the same alphanumerical references. For simplicity, the description of such parts and elements will not be repeated below, and reference should be made to the above description.

Differently from the first embodiment, peripheral sealing portion 106 is not a peripheral sealing lip. Instead, in this embodiment sealing portion 106 comprises an annular sealing gasket 120, e.g. an O-ring. Annular sealing gasket 120 may be mounted around the perimeter of outer lateral wall 104; as an alternative, sealing gasket 120 may be co-moulded with outer lateral wall 104, e.g. by using bi-injection techniques. Moreover, annular sealing gasket 120 is situated at the bottom of outer lateral wall 104.

In this second embodiment, sealing portion 106 consisting, in particular, of annular sealing gasket 120 is preferably obtained from elastomeric material, e. g. rubber. Whereas main body 102- and, particularly, outer lateral wall 104 of the latter-is made of plastic, more specifically thermoplastic material. With such a structure of piston 100 which is substantially a “bi-component” and/or “bi-material” structure-the elastomeric material is used for sealing portion 106 only, which is advantageous because the elastomeric material will tend to undesirably absorb part of product P and/or of the lubricant that facilitates the sliding action within hollow reservoir 12. Such absorption will, in fact, lead to a degradation of the properties and performance of the elastomeric part. This measure reduces to a minimum that part of piston 100 which can be affected by this problem.

Unlike those employed in the first embodiment, lateral extensions 108 do not consist only of teeth protruding transversally outwards from outer lateral wall 104. In this embodiment, the plurality of lateral extensions 108 comprise a plurality of tabs 124 tending to bend transversally outwards in contact with the inner wall of hollow reservoir 12. In particular, outer lateral wall 104 has a plurality of lateral recesses 122 mutually spaced apart along the perimeter of main body 102. From the bottom of each one of lateral recesses 122 an associated tab 124 protrudes axially, in particular like an upright.

Advantageously, tabs 124-since they are flexible facilitate the insertion of piston 100 through one end of hollow reservoir 12.

In this embodiment, lateral recesses 122 are grooves formed transversally on the outside of outer lateral wall 104. In particular, the grooves are oriented in a substantially axial direction.

In this embodiment, each tab 124 includes a stem portion 124a protruding axially from the base of the lateral recess 122, and a head portion 124b protruding transversally outwards from stem portion 124a. Preferably, head portion 124b has a shape which is similar to that of the tooth of the previous embodiment, e.g. with a substantially triangular cross-section and a vertex configured to come in contact with the inner walls of hollow reservoir 12.

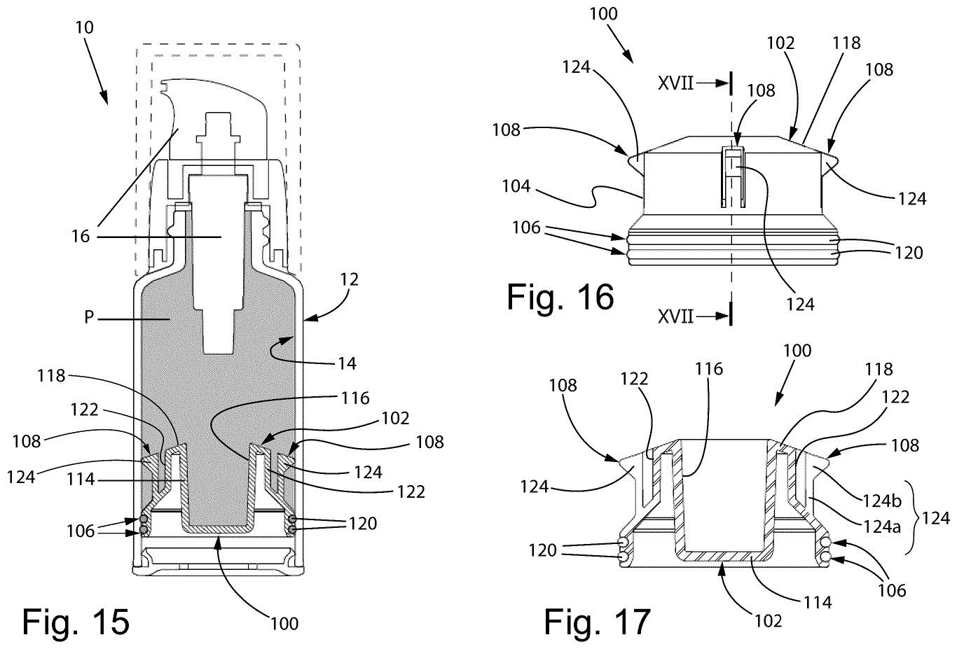

With reference to FIGS. 15 to 17, there is shown a container, still designated as 10, provided with a piston, still designated as 100, made in accordance with a third illustrative embodiment of the present invention.

Those parts and elements which are similar to- or which perform the same function as-those of the previously described embodiments have been assigned the same alphanumerical references. For simplicity, the description of such parts and elements will not be repeated below, and reference should be made to the above description.

Differently from the second embodiment, sealing portion 106 is not just a single annular sealing gasket. Instead, in this embodiment sealing portion 106 comprises a pair of annular sealing gaskets 120, e.g. a pair of O-rings, mounted around the perimeter of outer lateral wall 104 and axially spaced apart. Annular sealing gaskets 120 are situated at the bottom of outer lateral wall 104.

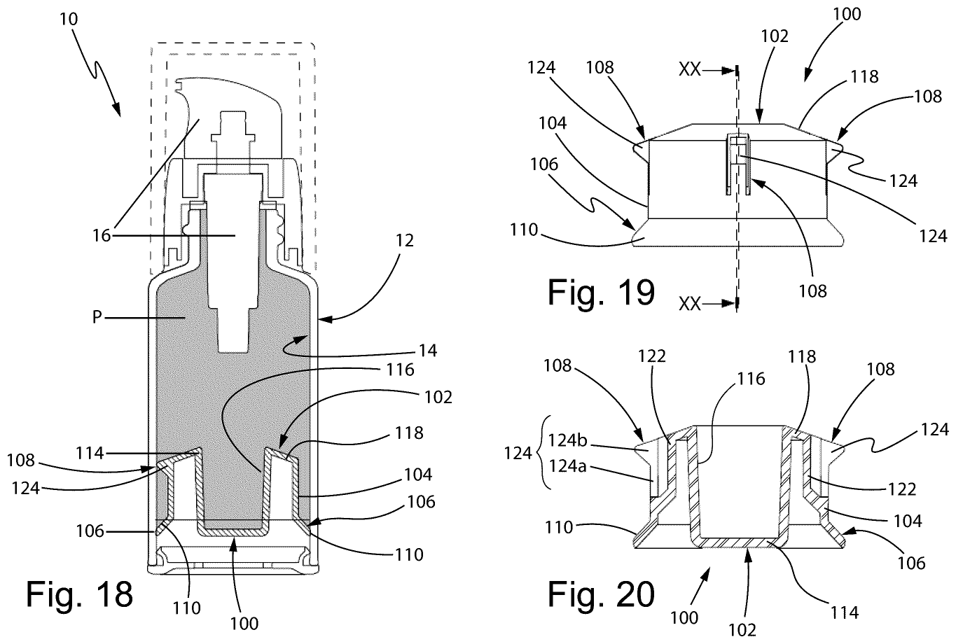

With reference to FIGS. 18 to 20, there is shown a container, still designated as 10, provided with a piston, still designated as 100, made in accordance with a fourth illustrative embodiment of the present invention.

Those parts and elements which are similar to—or which perform the same function as—those of the previously described embodiments have been assigned the same alphanumerical references. For simplicity, the description of such parts and elements will not be repeated below, and reference should be made to the above description.

Differently from the second embodiment, sealing portion 106 does not consist of annular sealing gaskets. Instead, in this embodiment sealing portion 106 comprises peripheral sealing lip 110 shown in the first embodiment, to which reference should be made for a description of its technical characteristics.

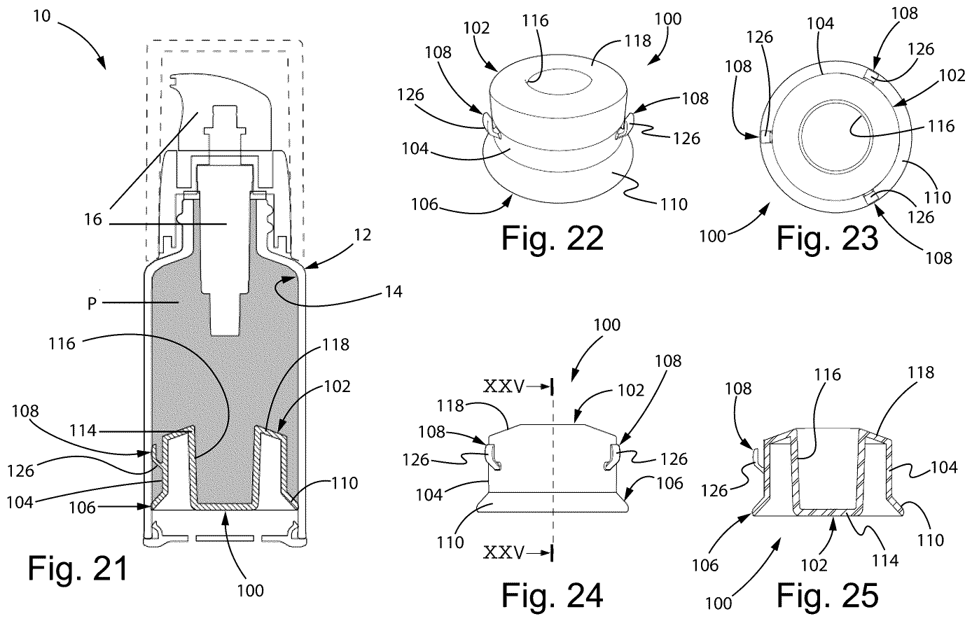

With reference to FIGS. 21 to 25, there is shown a container, still designated as 10, provided with a piston, still designated as 100, made in accordance with a fifth illustrative embodiment of the present invention.

Those parts and elements which are similar to—or which perform the same function as—those of the previously described embodiments have been assigned the same alphanumerical references. For simplicity, the description of such parts and elements will not be repeated below, and reference should be made to the above description.

Differently from the first embodiment, lateral extensions 108 do not consist of teeth. Instead, in this embodiment lateral extensions 108 comprise a plurality of arms 126 protruding transversally from lateral wall 14 and configured to slide along the inner walls of reservoir 12. Preferably, arms 126 are curved towards the top of main body 102.

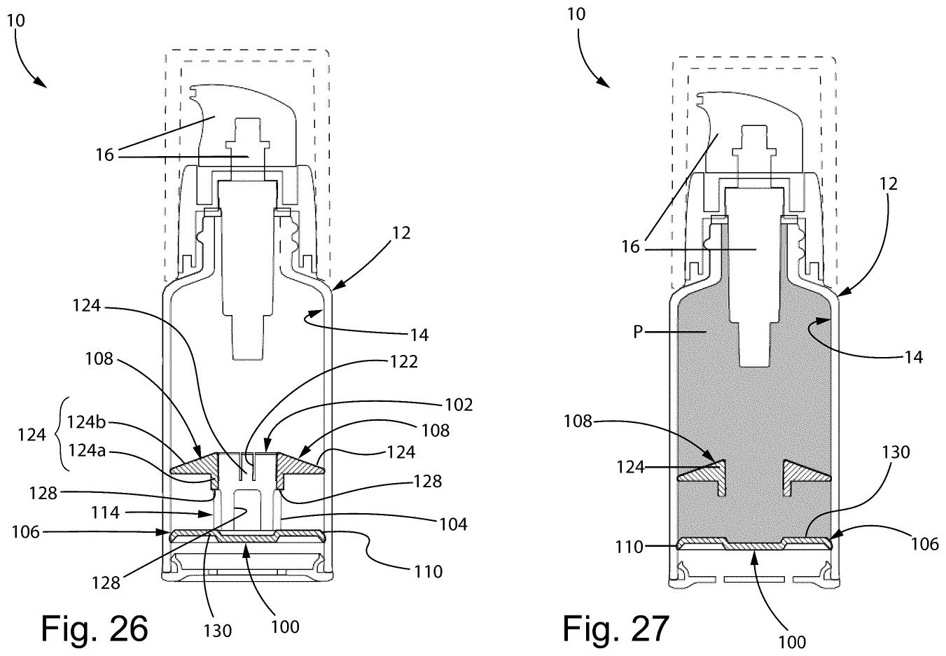

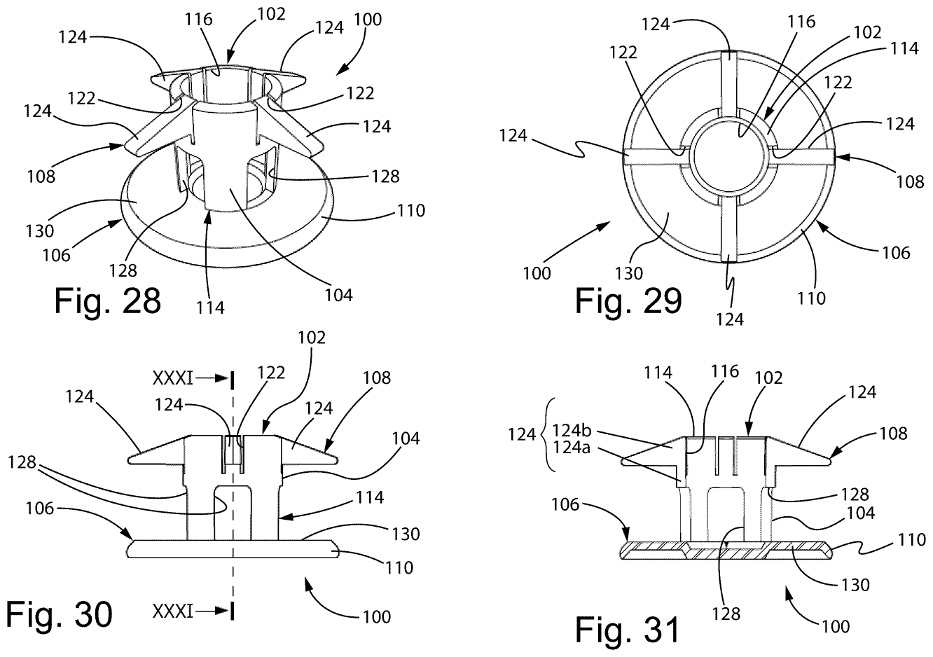

With reference to FIGS. 26 to 31, there is shown a container, still designated as 10, provided with a piston, still designated as 100, made in accordance with a sixth illustrative embodiment of the present invention.

Those parts and elements which are similar to—or which perform the same function as—those of the previously described embodiments have been assigned the same alphanumerical references. For simplicity, the description of such parts and elements will not be repeated below, and reference should be made to the above description.

FIG. 26 illustrates container 10 with no product P inside, so as to make more visible some details of piston 100 mounted therein. FIG. 27 depicts container 10 with product P contained in receptacle 14 and in contact with piston 100, so as to show the visibility of piston 100 through hollow reservoir 26.

Differently from the second embodiment, lateral wall 104 is defined by central part 114 itself, since the intermediate annular section that joins them is absent.

Differently from the second embodiment, lateral wall 104 defined by central part 114 has one or more lateral apertures 128 intended to be crossed transversally by product P. In the illustrated embodiment, product P can flow transversally within central part 114 and be retained by sealing portion 106. In particular, lateral apertures 18 are situated on lateral wall 104 axially underneath recesses 122 and tabs 124.

Differently from the second embodiment, main body 102 comprises a base plate 130 situated at the bottom of central part 114 and protruding transversally therefrom. Preferably, base plate 130 perimetrically carries sealing portion 106 that comprises peripheral sealing lip 110, which is made as described with reference to the previous embodiments.

Differently from the second embodiment, recesses 122 do not consist of grooves, but are notches that transversally cross lateral wall 104, which is particularly formed by central part 114. Within the gaps defined by the notches tabs 124 extend, which protrude axially from the bottom of such notches.

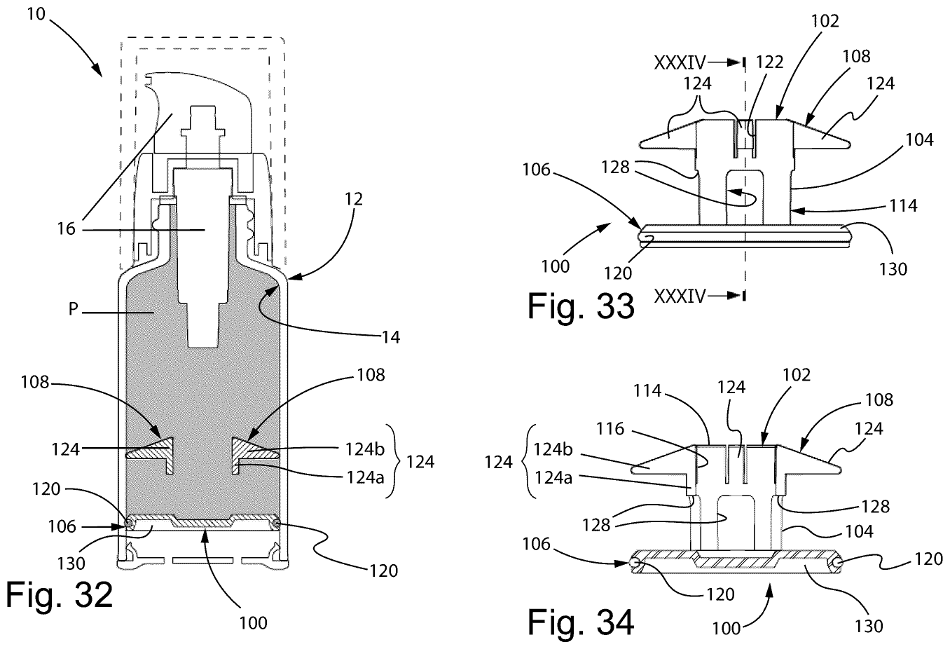

With reference to FIGS. 32 to 34, there is shown a container, still designated as 10, provided with a piston, still designated as 100, made in accordance with a seventh illustrative embodiment of the present invention.

Differently from the sixth embodiment, sealing portion 106 includes, instead of a peripheral sealing lip, a sealing gasket 120 made as described with reference to the previous embodiments. In particular, base plate 130 supports sealing gasket 120 transversally at its outer periphery.

Of course, without prejudice to the principle of the invention, the forms of embodiment and the implementation details may be extensively varied from those described and illustrated herein by way of non-limiting example, without however departing from the scope of the invention as set out in the appended claims.

For example, the technical features that differentiate the various embodiments and variants thereof described and illustrated interchangeable, whenever compatible.

1. A piston for a container provided with an airless dispenser for a fluid product; said piston comprising:
a main body having an outer lateral wall; and
a peripheral sealing portion protruding transversally outwards from said outer lateral wall and extending perimetrically in a substantially continuous manner around said main body; said peripheral sealing portion being configured to fluid-sealingly slide in a receptacle defined by an inner lateral surface of a hollow reservoir of said container;
a plurality of lateral extensions protruding transversally outwards from said outer lateral wall and being mutually spaced apart along the a perimeter of said main body; said lateral extensions being axially spaced from said peripheral sealing portion and being configured for sliding against the inner lateral surface of said hollow reservoir to guide movement of the piston in said receptacle;
wherein said peripheral sealing portion comprises:
a peripheral sealing lip that protrudes from said outer lateral wall and extends in a substantially continuous manner around said main body, or
at least one annular sealing gasket mounted perimetrically to said outer lateral wall; and
wherein said plurality of lateral extensions comprise:
a plurality of teeth mutually spaced apart along said outer lateral wall of said main body, or
a plurality of tabs tending to bend transversally outwards in contact with the inner surface of said hollow reservoir.

2. The piston according to claim 1, wherein said peripheral sealing portion and said lateral extensions are on axially opposite sides of said main body (102).

3. The piston according to claim 2, wherein said peripheral sealing portion is at or near a bottom of said main body.

4. The piston according to claim 1, wherein said lateral extensions are at or near a top of said main body.

5. The piston according to claim 1, wherein at least one of said sealing portion and said plurality of lateral extensions comprise one piece with the main body.

6. The piston according to claim 1, wherein said sealing portion comprises a pair of said annular sealing gaskets mounted perimetrically to the outer lateral wall and axially spaced apart.

7. The piston according to claim 1, wherein said outer lateral wall has a plurality of lateral recesses mutually spaced apart along the perimeter of said main body from a bottom of each of which an associated tab protrudes axially.

8. The piston according to claim 7, wherein the lateral recesses are grooves formed transversally on an outside of the outer lateral wall.

9. The piston according to claim 7, wherein the lateral recesses are notches that transversally cross the outer lateral wall.

10. The piston according to claim 7, wherein each tab includes a stem portion protruding axially from a base of said lateral recess and a head portion protruding transversally outwards from said stem portion.

11. The piston according to claim 1, wherein said outer lateral wall comprises at least one lateral aperture configured to be crossed transversally by said product.

12. The piston according to claim 1, wherein said main body and said plurality of lateral extensions are made of plastic.

13. The piston according to claim 12, wherein said peripheral sealing portion is made of elastomeric material.

14. The piston according to claim 12, wherein said peripheral sealing portion is made of plastic.

15. A container provided with an airless dispenser for a fluid product; said container comprising:
a hollow reservoir internally defining a receptacle configured to sealingly contain said product;
the piston according to claim 1;
an airless dispenser mounted on said hollow reservoir and operable by a user to create in said receptacle a vacuum acting upon said piston, so that the piston is attracted and pushes an amount or dose of said product contained in said receptacle out of said hollow reservoir.
